(19) United States
(12) Patent Application Publication
(10) Pub. No.: US 2013/0262847 A1
(43) Pub. Date: Oct. 3, 2013

(54) SWITCHING CIRCUIT FOR BASIC INPUT OUTPUT SYSTEM

(71) Applicants: HONG FU JIN PRECISION INDUSTRY (WUHAN) C, Wuhan (CN); HON HAI PRECISION INDUSTRY CO., LTD., New Taipei (TW)

(72) Inventors: HUA ZOU, Wuhan (CN); CHUN-SHENG CHEN, New Taipei (TW)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 13/672,782

(22) Filed: Nov. 9, 2012

(30) Foreign Application Priority Data
Apr. 2, 2012 (CN) 201210095495.1

(51) Int. Cl. G06F 15/177

(52) U.S. Cl. 713/2

(57) ABSTRACT

A switching circuit for a basic input/output system (BIOS) chip includes a front panel connector, a first connector, a second connector, and a BIOS chip. The first connector is selectively plugged into the front panel connector, a first pin of the first connector is coupled to a first pin of the second connector, and is grounded through a first resistor. The BIOS chip coupled to a first pin of the front panel connector, and coupled to a first power terminal through a second resistor. The BIOS chip loads different system configurations based on whether the first connector is plugged into the front panel connector or not plugged into the front panel connector.

### BACKGROUND

1. Technical Field

The present disclosure relates to a switching circuit for a basic input/output system (BIOS) chip.

2. Description of Related Art

When a computer boots up, a display will show information about the computer, such as the type of motherboard onboard, and the manufacturer's logo. Each series of motherboards may include different types, such as a series A may include a type A-1 motherboard and a type A-2 motherboard. The different types of motherboards from the same series may be the same except for having a different hard disk drive and a different optical drive, so that a BIOS may includes a first system configuration and a second system configuration for the two different motherboard types.

FIG. 3 is a circuit diagram of a conventional switch circuit. The switch circuit includes a BIOS chip 10. A first general purpose input output (GPIO) pin GPIO1 is coupled to a power terminal 3V through a resistor R1, and is grounded through a resistor R2. A second GPIO pin GPIO2 is coupled to the power terminal 3V, and is grounded through a resistor R4. When the computer boots up, the BIOS chip 10 loads different system configurations according to the voltage levels of the first and second GPIO pins GPIO1 and GPIO2.

For example, when a type A-1 motherboard is installed in a computer, the resistors R2 and R3 should be removed, so that the first GPIO pin GPIO1 will be at a high level, and the second GPIO pin GPIO2 will be at a low level. Thus, the BIOS chip 10 determines that the first system configuration should be loaded at power-up. When a type A-2 motherboard is installed in the computer, the resistors R4 and R1 should be removed, so that the first GPIO pin GPIO1 will be at a low level, and the second GPIO pin GPIO2 will at a high level. Thus, the BIOS chip 10 determines that the second system configuration should be loaded at power-up. The procedure of a technician manually removing certain resisters during installation of motherboards is susceptible to error and time consuming.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIGS. 1 and 2 are circuit diagrams of an embodiment of a switching circuit for a basic input/output system (BIOS) of the present disclosure.

FIG. 3 is a circuit diagram of a related art.

### DETAILED DESCRIPTION

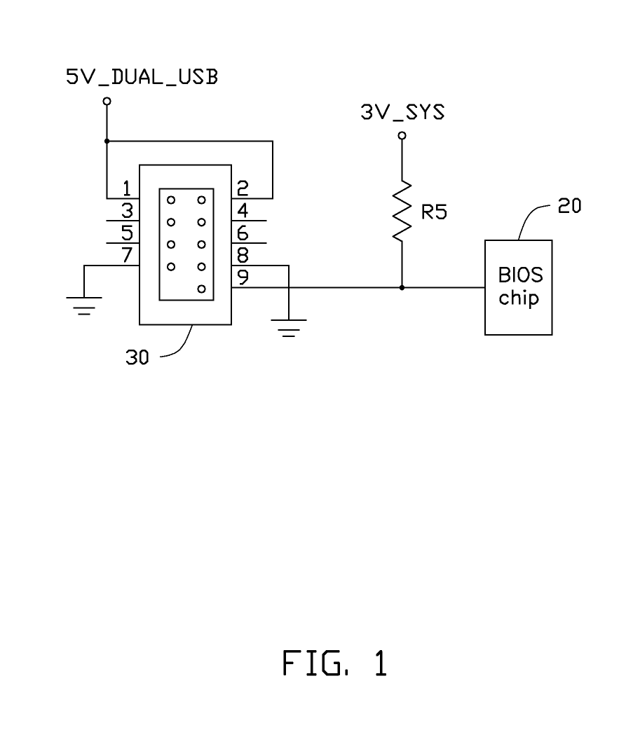

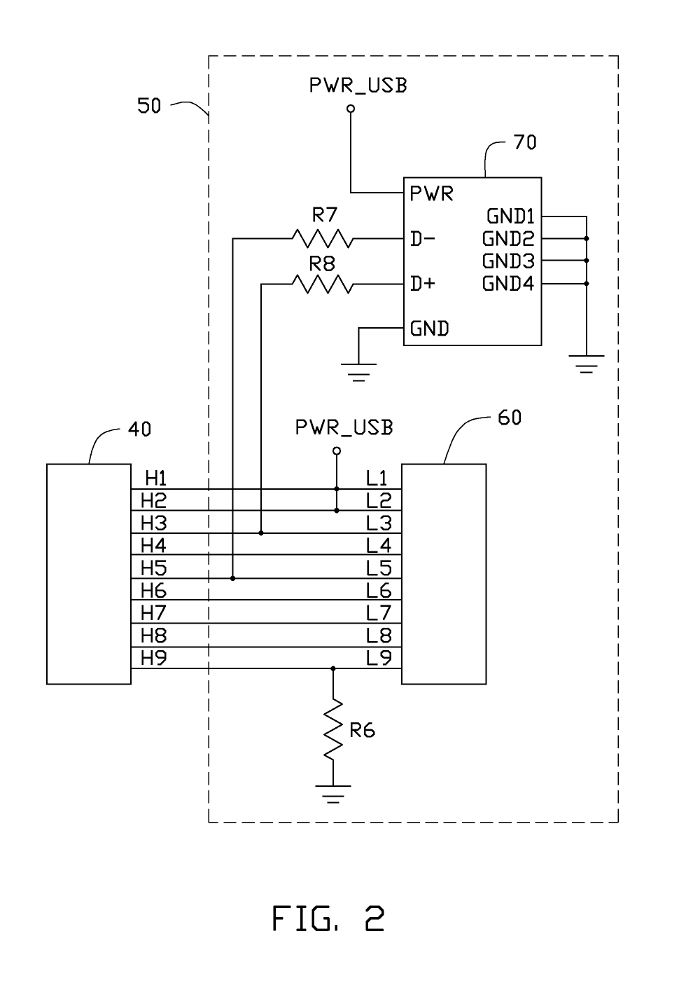

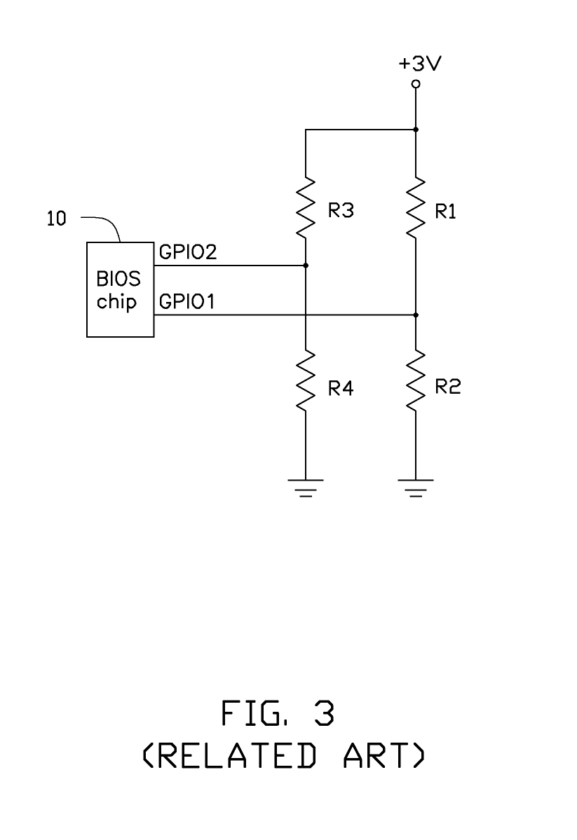

FIGS. 1 and 2 illustrate an embodiment of a switching circuit for a basic input/output system (BIOS) chip of the present disclosure. The switching circuit includes a front panel connector 30, a BIOS chip 20 coupled to the front panel connector 30, a circuit board 50 selectively plugged into the front panel connector 30 through a first connector 40.

A first pin 1 and a second pin 2 of the front panel connector 30 are coupled to a power terminal 5V_DUAL_USB of a motherboard. A third pin 3 is a first negative data pin; a fourth pin 4 is a second negative data pin. A fifth pin 5 is a first positive data pin; a sixth pin 6 is a second positive data pin. A seventh pin 7 and eighth pin 8 are grounded. A ninth pin 9 is coupled to the BIOS chip 20, and coupled to a power terminal 3V_SYS through a resistor R5.

The circuit board 50 includes a second connector 60 and a control chip 70. First to ninth pins L1-L9 of the second connector 60 are coupled to first to ninth pins H1-H9 of the first connector 40, respectively. The ninth pin L9 of the second connector 60 is grounded through a resistor R6. A negative data pin D1 of the control chip 70 is coupled to the third pin L3 of the second connector 60 through a resistor R8, and a positive data pin D+ of the control chip 70 is coupled to the fifth pin L5 of the second connector 60 through a resistor R8. The first and second pins L1 and L3 are coupled to a power terminal PWR_USB. A power pin PWR of the control chip 70 is coupled to the power terminal PWR_USB, and ground pins GND and GND1-GND4 of the control chip are grounded. The control chip 70 is configured to communicate with components coupled to the front panel connector 30. When the first connector 40 is plugged into the front panel connector 30, the first to ninth pins L1-L9 of the second connector 60 are electronically coupled to the first to ninth pins 1-9 of the front panel connector 30 through the first to ninth pins H1-H9 of the first connector 40, respectively.

If a low level, such as logical 0, is received from the ninth pin 9 of the front panel connector 30 by the BIOS chip 20, the BIOS chip 20 will load a first system configuration, and if a high level, such as logical 1, is received from the ninth pin 9 of the front panel connector 30, the BIOS chip 20 will load a second system configuration.

When the first connector 40 is not plugged into the front panel connector 30, the ninth pin 9 of the front panel connector 30 is at a high level because of the power terminal 3V_SYS being coupled to the ninth pin 9. Therefore, the BIOS chip 20 loads the second system configuration at power-up. When the first connector 40 is plugged into the front panel connector 30, the first to ninth pin H1-H9 of the first connector 40 is coupled to the first to ninth pin 1-9 of the front panel connector 30, respectively. Thereafter, the negative data pin D− and positive data pin D+ of the control chip 70 are coupled to the fifth pin 5 and third pin 3 of the front panel connector 30 through resistors R7 and R8, respectively. And the ninth pin H9 of the first connector 40 is grounded through the resistor R6. Consequently, the ninth pin 9 of the front panel connector 30 is at low level, and the BIOS chip 20 loads the first system configuration.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A switching circuit for a basic input/output system (BIOS) chip, comprising:
a front panel connector;
a first and second connectors, wherein the first connector is selectively plugged into the front panel connector, a first pin of the first connector is coupled to a first pin of the second connector, and is grounded through a first resistor; and
the BIOS chip coupled to a first pin of the front panel connector, and coupled to a first power terminal through a second resistor;
wherein when the first connector is not plugged into the front panel connector, the BIOS chip loads a first system configuration, and when the first connector is plugged into the front panel connector, the first pin of the first connector is coupled to the first pin of the front panel connector, the BIOS chip loads a second system configuration.

2. The switching circuit of claim 1, further comprising a control chip, wherein a second to ninth pins of the second connector are coupled to a second to ninth pins of the front panel connector through a second to ninth pins of the first connector, respectively, a negative data pin of the control chip is coupled to the sixth pin of the first connector through a third resistor, and a positive data pin of the control chip is coupled to a fourth pin of the first connector through a fourth resistor, the fourth and sixth pins of the first connector are coupled to the fourth and sixth pins of the front panel connector as the first connector is plugged into the front panel.
